(19) United States
(12) Patent Application Publication
(10) Pub. No.: US 2009/0315457 A1
(43) Pub. Date: Dec. 24, 2009

(54) Flexible organic EL display and method of manufacturing the same

(75) Inventors: Tadahiro Furukawa, Tokyo (JP); Masayuki Hosoi, Tokyo (JP); Shizuo Tokito, Tokyo (JP); Toshihiro Yamamoto, Tokyo (JP); Yoshiki Nakajima, Tokyo (JP); Yoshihide Fujisaki, Tokyo (JP); Tatsuya Takei, Tokyo (JP)

Correspondence Address: BACON & THOMAS, PLLC, 625 SLATERS LANE, FOURTH FLOOR, ALEXANDRIA, VA, 22314-1176, US

(73) Assignees: KYODO PRINTING CO., LTD., Tokyo (JP); NIPPON HOSO KYOKAI, Tokyo (JP)

(21) Appl. No.: 12/457,819

(22) Filed: Jun. 23, 2009

(30) Foreign Application Priority Data
Jun. 24, 2008 (JP) 2008-164382

(51) Int. Cl. H01J 1/62; H01J 9/00

(52) U.S. Cl. 313/504; 445/24

(57) ABSTRACT

A flexible organic EL display of the present invention includes a plastic film, an adhesive layer and a lower insulating layer formed thereon, an organic EL element embedded in the lower insulating layer and constructed by forming an anode, an organic EL layer, and a cathode sequentially from a bottom, an upper insulating layer formed on the organic EL element, a TFT embedded in the upper insulating layer and constructed by forming an oxide semiconductor layer, a source electrode and a drain electrode, a gate insulating layer, and a gate electrode sequentially from a bottom, and a via hole provided in the upper insulating layer and reaching the drain electrode of the TFT, wherein the cathode is connected electrically to the drain electrode of the TFT via the via hole.

### CROSS-REFERENCE TO RELATED APPLICATIONS

This application is based on and claims priority of Japanese Patent Application No. 2008-164382 filed on Jun. 24, 2008, the entire contents of which are incorporated herein by reference.

### BACKGROUND OF THE INVENTION

1. Field of the Invention

The present invention relates to a flexible organic EL display employing a plastic film as a substrate and a method of manufacturing the same.

2. Description of the Related Art

An organic EL (Electroluminescence) display is expanding rapidly its applications into an information equipment, and the like. Recently the flexible display employing a plastic film as a substrate attracts attention. Such flexible display can be utilized not only for the ultra-slim and lightweight mobile display, which can be rounded and housed and is convenient for carrying, but also for the large display.

However, the plastic film possesses weak stiffness and has a low heat distortion temperature. Therefore, heat distortion such as warp, expansion/contraction, or the like easily occurs in the manufacturing step accompanied by heat treatment. For this reason, in the manufacturing method of forming various elements directly on the plastic film, the conditions of the manufacturing step accompanied by heat treatment, etc. are restricted, and high-precision alignment becomes difficult. As a result, in some cases the element substrate having desired characteristics can not be manufactured.

In order to avoid such problem, there is the method of manufacturing the element substrate for the liquid crystal display device by aligning the amorphous silicon TFT element, the color filter, etc. on the heat resistant and stiff glass substrate with high precision under the unlimited manufacturing conditions, thereby to constitute the transfer layer, and then transferring the transfer layer onto the plastic film (Patent Literature 1 (Patent Application Publication (KOKAI) 2001-356370)).

Also, the flexible display needs the flexible TFT element that can follow the bending. It is feared that the amorphous silicon TFT or the low-temperature polysilicon TFT as the driving transistor in the prior art cannot obtain satisfactory reliability. Therefore, as the driving transistor for the flexible display, the TFT employing the organic semiconductor or the oxide semiconductor that is flexible and can follow the bending as the active layer attracts attention.

In Patent Literature 2 (Patent Application Publication (KOKAI) 2003-255857), it is set forth that the organic EL display is manufactured by forming sequentially the gate electrode, the gate insulating film, the organic semiconductor layer, and source/drain electrodes on the plastic substrate, or the like, and then forming the organic EL element on the anode which is connected to the drain electrode.

Also, in Patent Literature 3 (Patent Application Publication (KOKAI) 2007-96055), it is set forth that the semiconductor device including the thin film transistor using the oxide semiconductor such as the zinc oxide, or the like.

Meanwhile, the organic semiconductor layer and the organic EL layer have such a problem that performance is degraded by the photolithography or etching step accompanied by the process using organic solvent, water, plasma, electron beam, heat treatment, or the like, and in turn these layers hardly function.

Also, the technology to construct the flexible organic EL display by forming the TFT using the oxide semiconductor and the organic EL element on the plastic film has not been sufficiently established. A method of forming the desired TFT using the oxide semiconductor and the desired organic EL element stably on the plastic film with high yield is earnestly demanded.

### SUMMARY OF THE INVENTION

It is an object of the present invention to provide a flexible organic EL display in which a desired oxide semiconductor TFT and an organic EL element are formed stably on a plastic film with high yield, and a method of manufacturing the same.

The present invention is concerned with a flexible organic EL display of active matrix type in which a TFT and an organic EL element are provided in every pixel, which includes a plastic film; an adhesive layer formed on the plastic film; a lower insulating layer formed on the adhesive layer; the organic EL element embedded in the lower insulating layer and constructed by forming an anode, an organic EL layer, and a cathode sequentially from a bottom; an upper insulating layer formed on the organic EL element; the TFT embedded in the upper insulating layer, and constructed by forming an oxide semiconductor layer, a source electrode and a drain electrode, a gate insulating layer, and a gate electrode sequentially from a bottom; and a via hole provided in the upper insulating layer and reaching the drain electrode of the TFT; wherein the cathode is connected electrically to the drain electrode of the TFT via the via hole.

The flexible organic EL display of the present invention is manufactured in such a way that the transfer layer including the TFT, the insulating layer for coating the TFT, the organic EL element, and the insulating layer for coating the element is formed in a peelable state on the temporary substrate (the glass substrate, or the like), and then the transfer layer is transferred/formed on the plastic film via the adhesive layer in a state that the top and bottom reverses. Therefore, the TFT and the organic EL element are transferred onto the plastic film in a state that the top and bottom reverses from the structure that is formed on the temporary substrate.

By this matter, the TFT is composed of the oxide semiconductor layer, the source electrode and the drain electrode, the gate insulating layer, and the gate electrode sequentially from the bottom, and is embedded in the upper insulating layer. Also the organic EL element is composed of the anode, the organic EL layer, and the cathode sequentially from a bottom, and is embedded in the lower insulating layer.

Then, the via hole reaching the drain electrode of the TFT is provided in the upper insulating layer in which the TFT is embedded, and the cathode is connected electrically to the drain electrode of the TFT via the via hole.

In the present invention, since such transfer technology is employed, the organic EL element is formed under the TFT such that this element is protected by the lower insulating layer and the upper insulating layer and is embedded therein. As a result, such a situation can be prevented that steam from an outside air and moisture in the plastic film enter into the organic EL element, and thus reliability of the organic EL element can be improved.

Also, in the preferred mode of the present invention, the gate insulating layer of the TFT is formed of an insulating layer which contains no hydroxyl group and is obtained by polymerizing/cross-linking poly vinyl phenol, poly methyl silsesquioxane, or polyimide by applying a heat treatment (anneal). In the present invention, since the transfer technology is utilized, the insulating layer containing no hydroxyl group can be formed by heat-treating the coating film such as poly vinyl phenol, or the like at a temperature of 180° C. or more on the heat-resistant temporary substrate, in the formation of the gate insulating layer. Therefore, the gate insulating layer which has a sufficient dielectric breakdown electric field strength (1 MV/cm or more) and can follow a bending stress can be transferred/formed on the plastic film easily.

Further, the transfer technology is utilized in the present invention. Therefore, in the formation of the oxide semiconductor TFT, the oxide semiconductor layer can be thermally treated on the heat-resistant temporary substrate at a temperature of 200° C. or more. As a result, the oxide semiconductor layer acting as the active layer of the TFT having the desired electric characteristics (Vth, etc.) can be transferred easily onto the plastic film.

Also, the present invention is concerned with a method of manufacturing a flexible organic EL display of active matrix type in which a TFT and an organic EL element are provided in every pixel, which includes the steps of forming a transparent peelable layer on a temporary substrate; forming the TFT constructed by forming a gate electrode, a gate insulating layer, a source electrode and a drain electrode, and an oxide semiconductor layer over the transparent peelable layer sequentially from a bottom; forming a first insulating layer on the TFT; forming a via hole reaching the drain electrode of the TFT, by processing the first insulating layer; forming the organic EL element composed of a cathode connected to the drain electrode via the via hole, an organic EL layer formed on the cathode, and an anode formed on the organic EL layer, on the first insulating layer; forming a second insulating layer on the organic EL element; adhering a plastic film onto the second insulating layer via an adhesive layer; and transferring/forming the second insulating layer, the organic EL element, the first insulating layer, the TFT, and the transparent peelable layer onto the plastic film via the adhesive layer, by peeling the temporary substrate along a boundary between the temporary substrate and the transparent peelable layer.

By using the manufacturing method of the present invention, the foregoing flexible organic EL display of the present invention can be manufactured easily.

In the present invention, the transparent peelable layer is used as the separating layer at a time of the transfer operation. Thus, the transparent peelable layer exposed after the temporary substrate is peeled off can be utilized as the surface protection layer. Therefore, in the manufacturing method utilizing the transfer technology, there is no necessity to remove the peeling layer or to form particularly the surface protection layer. As a result, the manufacturing steps can be simplified and a cost reduction can be achieved.

As explained above, in the present invention, the desired oxide semiconductor TFT and the desired organic EL element can be formed stably on the plastic film with high yield.

### BRIEF DESCRIPTION OF THE DRAWINGS

FIGS. 1A and 1B are sectional views (#1) showing a method of manufacturing a flexible organic EL display according to an embodiment of the present invention;

FIGS. 2A and 2B are sectional views (#2) showing the method of manufacturing the flexible organic EL display according to the embodiment of the present invention;

FIGS. 3A and 3B are sectional views (#3) showing the method of manufacturing the flexible organic EL display according to the embodiment of the present invention;

FIG. 4 is a sectional view (#4) showing the method of manufacturing the flexible organic EL display according to the embodiment of the present invention;

FIG. 5 is a sectional view (#5) showing the method of manufacturing the flexible organic EL display according to the embodiment of the present invention;

FIG. 6 is a sectional view (#6) showing the method of manufacturing the flexible organic EL display according to the embodiment of the present invention;

FIG. 7 is a sectional view (#1) showing the flexible organic EL display according to the embodiment of the present invention;

FIG. 8 is a view showing an equivalent circuit of one pixel portion of the flexible organic EL display according to the embodiment of the present invention;

FIG. 9 is a plan view showing an example of a layout of the pixel portion in the flexible organic EL display according to the embodiment of the present invention;

FIG. 10 is a sectional view (#2) showing the flexible organic EL display according to the embodiment of the present invention;

FIG. 11 is an external view showing an external connection area of the flexible organic EL display according to the embodiment of the present invention;

FIG. 12 is a view showing a sectional state in the longitudinal direction of a gate connection electrode in the external connection area in FIG. 11; and

FIG. 13 is a view showing a sectional state in the longitudinal direction of a source connection electrode in the external connection area in FIG. 11.

### DETAILED DESCRIPTION OF THE PREFERRED EMBODIMENTS

An embodiment of the present invention will be explained with reference to the accompanying drawings hereinafter.

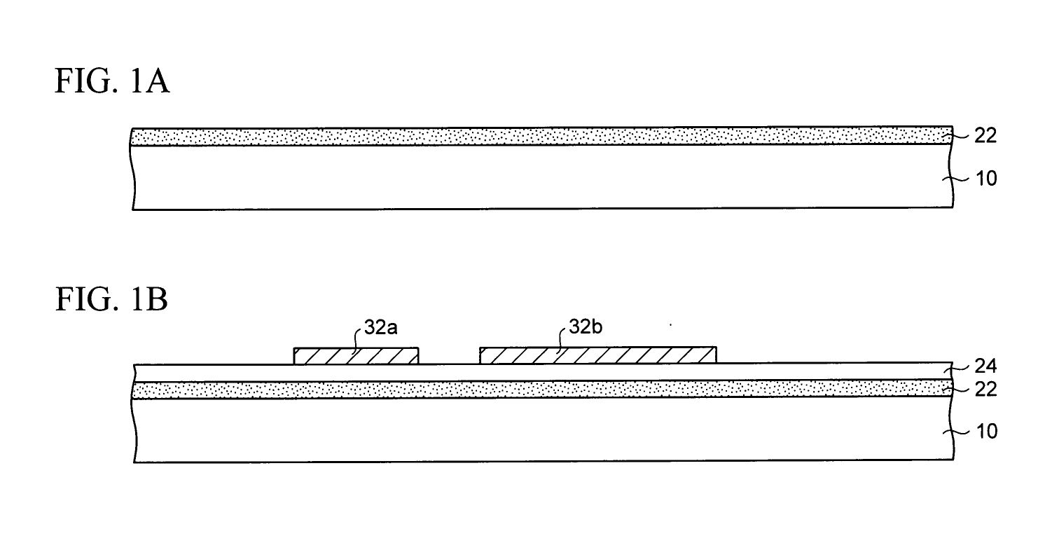

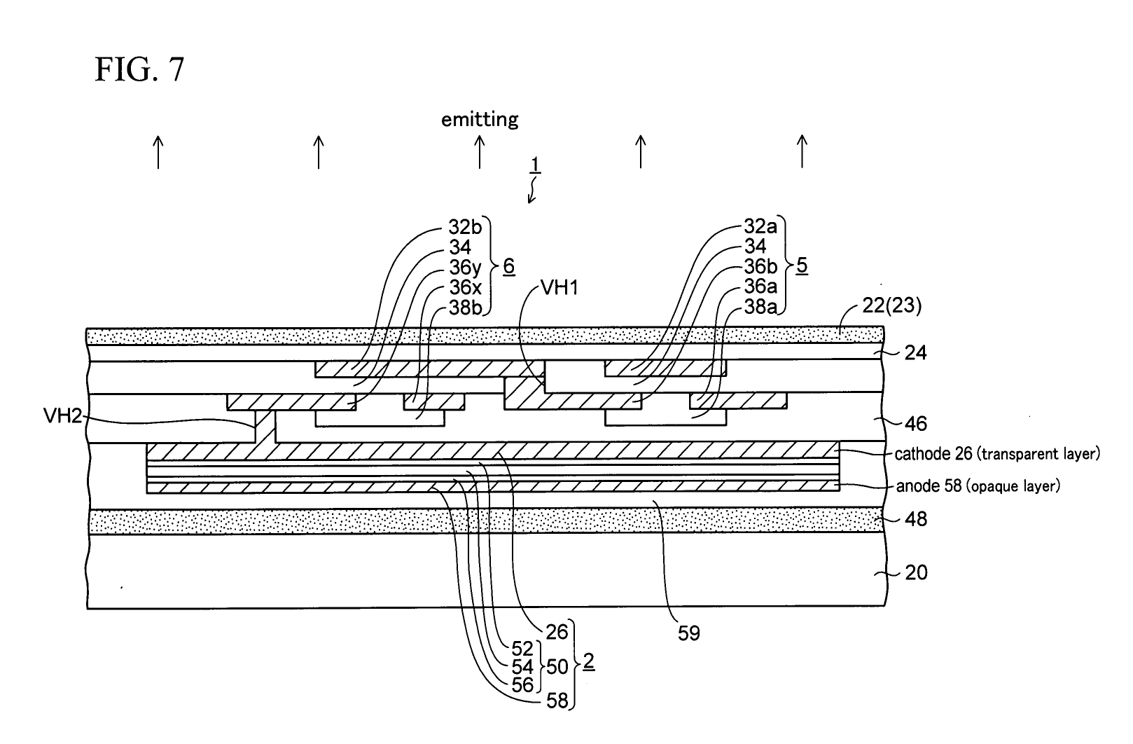

FIGS. 1A and 1B, FIGS. 2A and 2B, FIGS. 3A and 3B, and FIG. 4 to FIG. 6 are sectional views showing a method of manufacturing a flexible organic EL display according to an embodiment of the present invention, and FIG. 7 is a sectional view showing the flexible organic EL display similarly.

In the method of manufacturing the flexible organic EL display according to the present embodiment, as shown in FIG. 1A, first, a glass substrate 10 is prepared as a temporary substrate, and a transparent peelable layer 22 is formed on the glass substrate 10. As described later, the transparent peelable layer 22 functions as a separating layer when the transfer layer formed on the glass substrate 10 is transferred on the plastic film, and also is left on the display, thereby functions as a transparent surface protection layer.

The transparent peelable layer 22 is formed of a polyimide layer that is obtained by condensing tetracarboxylic acid (anhydride) and diamine. As the tetracarboxylic acid (anhydride), benzophenone tetracarboxylic anhydride or pyromellitic acid anhydride is employed. Also, as the diamine, 3,3′-diaminodiphenyl sulfone, 4,4′-diaminodiphenyl sulfone, 3,3′-diaminobenzophenone, or 4,4′-diaminobenzophenone is employed.

Such polyimide layer is transparent until its film thickness is about 5 μm. However, when its film thickness is increased up to a thickness of about 20 μm that functions as a complete film, this polyimide layer is tinged with yellowish. This coloring is caused due to the basicity of amine, and thus this yellow coloring can be weakened by reducing the basicity of amine. That is, when a film thickness of the transparent peelable layer 22 is set thick, this coloring can be weakened by using the diamine that is coupled with substituent having electron-suction property.

In this case, when the coloring does not become an issue, 3,3′-diaminodiphenyl ether, 4,4′-diaminodiphenyl ether, or the like may be employed as the amine.

Then, as shown in FIG. 1B, a buffer layer 24 formed of an inorganic insulating layer such as a silicon oxide layer (SiOₓ), a silicon nitride layer (SiNₓ), or the like is formed on the transparent peelable layer 22. Then, a gate electrode 32a for a switching TFT (Thin Film Transistor) (referred to as a “Sw-TFT” hereinafter) and a gate electrode 32b for a driving TFT (referred to as a “Dr-TFT” hereinafter) are formed on the buffer layer 24.

The gate electrodes 32a, 32b are formed by forming an aluminum (Al) layer, chrome (Cr) layer, a gold (Au) layer, an ITO (Indium Tin Oxide) layer, an IZO (Indium Zinc Oxide) layer, or the like by using the sputter method, or the like, and then patterning the layer by using the photolithography and the etching.

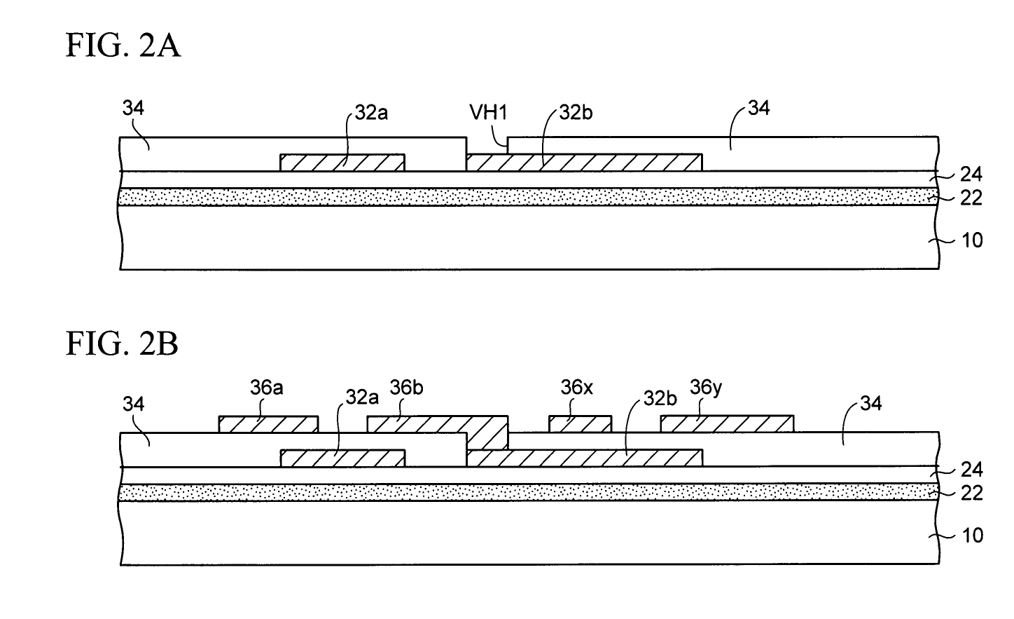

Then, as shown in FIG. 2A, a gate insulating layer 34 is formed on the gate electrodes 32a, 32b. As the preferred example of the method of forming the gate insulating layer 34, such a method is employed that a coating film is formed by coating a coating liquid such as poly vinyl phenol, poly methyl silsesquioxane (organic/inorganic composite material), polyimide, or the like, and then the coating film is heat-treated for about one hour in a temperature atmosphere of 180° C. or more (180 to 250° C.) to cause it to polymerize/cross-link. In this case, the coating material in which polymerization/crosslinking is caused by the ultraviolet irradiation can be also employed.

In the present embodiment, because the flexible display is manufactured by utilizing the transfer technology, the gate insulating layer 34 is formed on the heat-resistant glass substrate 10. Therefore, the coating film can be heat-treated at a desired temperature. As a result, the gate insulating layer 34 not containing a hydroxyl group can be obtained easily from the above coating material.

In the gate insulating layer 34 obtained by such method and not containing a hydroxyl group, dielectric breakdown electric field strength of 1 MV/cm or more can be obtained and a flexible insulating layer which follows a bending stress is constituted. Thus, this flexible insulating layer can be employed preferably as the TFT gate insulating layer of the flexible display.

Otherwise, an inorganic insulating layer such as a silicon oxide layer (SiOₓ), a silicon nitride layer (SiN), a tantalum oxide layer (Ta₂O₅), or the like may be employed as the gate insulating layer 34.

Then, the gate insulating layer 34 is processed by the photolithography and the etching. Thus, a first via hole VH1 reaching the gate electrode 32b of the Dr-TFT is formed.

Then, as shown in FIG. 2B, a source electrode 36a and a drain electrode 36b of the Sw-TFT are formed on the gate insulating layer 34 as a pattern respectively. At the same time, a source electrode 36x and a drain electrode 36y of the Dr-TFT are formed on the gate insulating layer 34 as a pattern respectively. The source electrodes 36a, 36x and the drain electrodes 36b, 36y are arranged such that opposing regions between them (channel regions) overlap with the gate electrodes 32a, 32b respectively.

At this time, the drain electrode 36b of the Sw-TFT is connected electrically to the gate electrode 32b of the Dr-TFT via the first via hole VH1. The source electrodes 36a, 36x and the drain electrodes 36b, 36y are formed by patterning the conductive layer made of the same material as the gate electrodes 32a, 32b by using the photolithography and the etching.

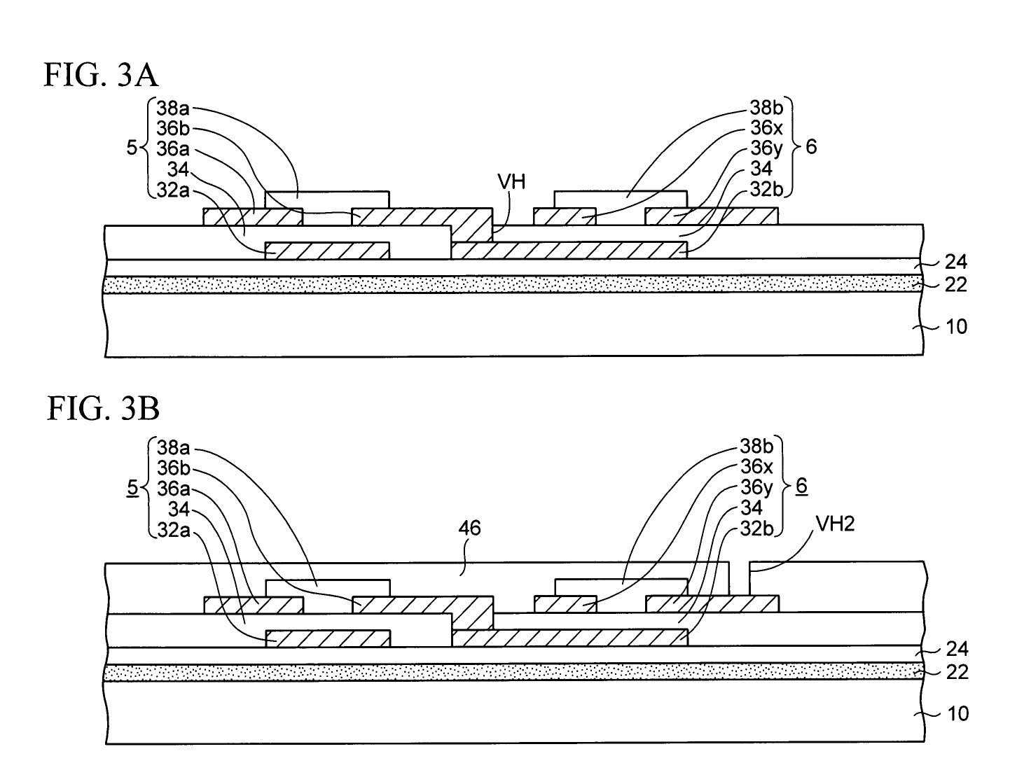

Then, as shown in FIG. 3A, an oxide semiconductor layer 38a for the Sw-TFT are patterned and formed from on the source electrode 36a and the drain electrode 36b of the Sw-TFT to on the gate insulating layer 34 located between them. At the same time, an oxide semiconductor layer 38b for the Dr-TFT are patterned and formed from on the source electrode 36x and the drain electrode 36y of the Dr-TFT to on the gate insulating layer 34 located between them.

As the oxide semiconductor layers 38a, 38b, a transparent amorphous oxide semiconductor made of indium (In)-zinc (Zn)-oxygen (O) series, indium (In)-Zinc (Zn)-gallium (Ga)-oxygen (O) series, or the like is employed.

As the method of forming the oxide semiconductor layers 38a, 38b, first, an oxide semiconductor layer made of the above material (film thickness: 50 to 100 nm) is formed like a blanket on the source electrodes 36a, 36x and the drain electrodes 36b, 36y, and the gate insulating layer 34 by the sputter method.

Then, the oxide semiconductor layer is heat-treated (annealed) in a temperature atmosphere of 200° C. or more (200° C. to 300° C. (preferably 250° C. or more)). Then, the oxide semiconductor layer is patterned by the photolithography and the etching. The oxide semiconductor layer formed by the sputter method functions as the active layer of the TFT with the desired electric characteristics (Vth, etc.) by applying the heat treatment at about 200° C. In the present embodiment, the oxide semiconductor layers 38a, 38b is an n-type semiconductor.

In the present embodiment, as described later, the oxide semiconductor layers 38a, 38b is formed on the heat-resistant glass substrate 10, and then transferred onto the plastic film. Therefore, in forming the oxide semiconductor layers 38a, 38b, the heat treatment can be applied at a desired temperature. On the contrary, in the case that the oxide semiconductor layer is directly formed on the plastic film, the heat treatment in excess of 200° C. cannot be applied because the expansion/contraction of the plastic film is caused. Therefore, it is difficult to form the oxide semiconductor layer with the desired electric characteristics.

Accordingly, a Sw-TFT 5 composed of the gate electrode 32a, the gate insulating layer 34, the source electrode 36a, the drain electrode 36b, and the oxide semiconductor layer 38a connected electrically to the source electrode 36a and the drain electrode 36b, is obtained. Also, a Dr-TFT 6 composed of the gate electrode 32b, the gate insulating layer 34, the source electrode 36x, the drain electrode 36y, and the oxide semiconductor layer 38b connected electrically to the source electrode 36x and the drain electrode 36y, is obtained. Then, the drain electrode 36b of the Sw-TFT 5 is connected electrically to the gate electrode 32b of the Dr-TFT 6 via the first via hole VH.

Then, as shown in FIG. 3B, a first protection insulating layer 46 is formed on the Sw-TFT 5 and the Dr-TFT 6 to cover them. Preferably the first protection insulating layer 46 should be formed by stacking an inorganic insulating layer such as a silicon oxide layer (SiOₓ), a silicon nitride layer (SiNₓ), or the like on a resin layer made of an acrylic resin, or the like. Otherwise, the first protection insulating layer 46 may be formed by forming a resin layer on an inorganic insulating layer.

Then, the first protection insulating layer 46 is processed by the photolithography and the etching. Thus, a second via hole VH2 reaching the drain electrode 36y of the Dr-TFT 6 is formed.

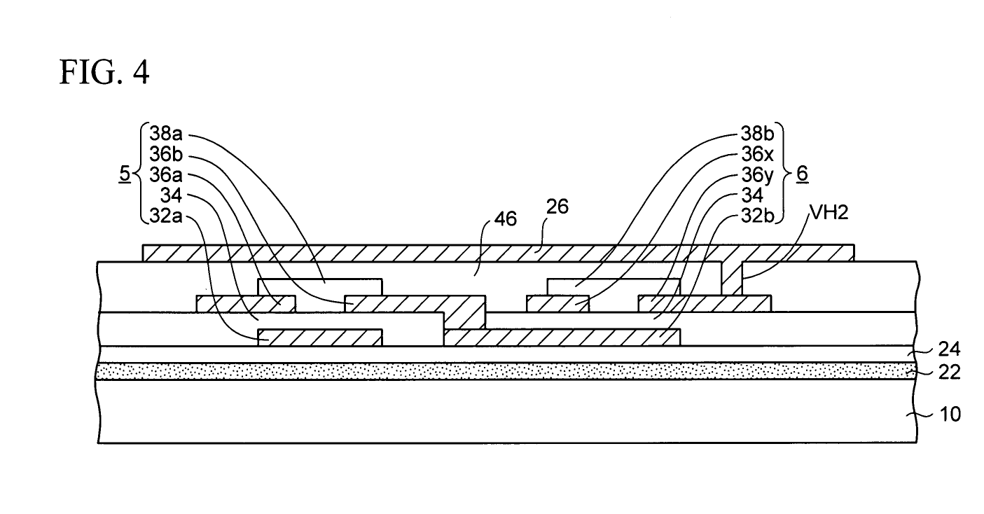

Then, as shown in FIG. 4, a cathode 26 connected electrically to the drain electrode 36y of the Dr-TFT 6 via the second via hole VH2 is patterned and formed on the first protection insulating layer 46. This cathode 26 may be formed of a transparent conductive layer such as an ITO (Indium Tin Oxide) layer, an IZO (Indium Zinc Oxide) layer, or the like. Otherwise, the cathode 26 may be formed of an opaque conductive layer such as a gold (Au) layer, a platinum (Pt) layer, a silver (Ag) layer, or the like. The cathode 26 is formed by patterning a conductive layer which is formed by the sputter method, by using the photolithography and the etching.

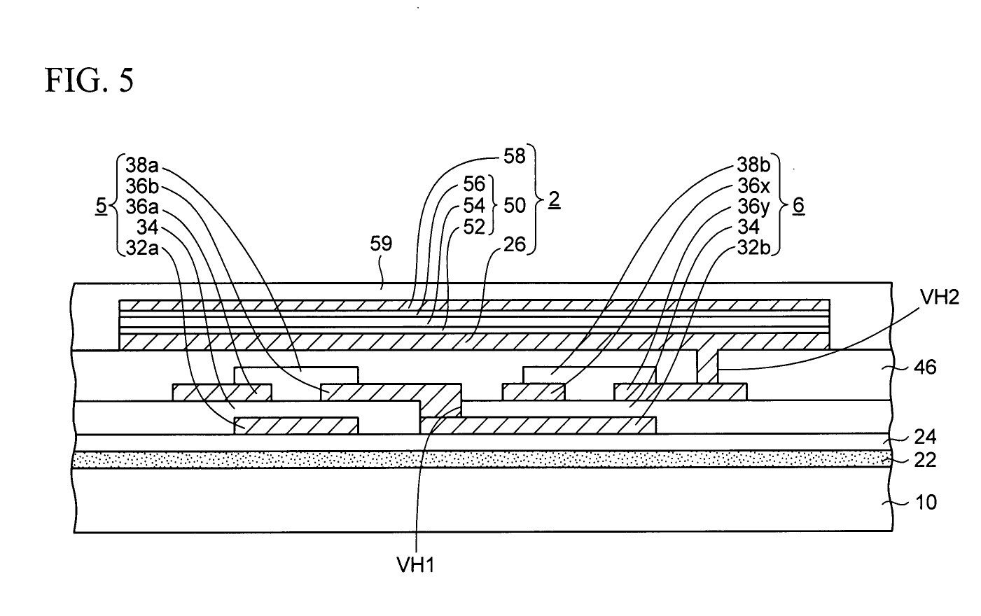

Then, as shown in FIG. 5, an electron transporting layer 52 is formed selectively on the cathode 26 by the mask deposition method, or the like. As the electron transporting layer 52, a quinolinol aluminum complex (Alq3), or the like is employed preferably.

Then, as also shown in FIG. 5, a light emitting layer 54 of low polymer-series whose film thickness is 70 nm, for example, is formed selectively on the electron transporting layer 52 by the mask deposition method, or the like.

As the light emitting layer 54 of low polymer-series, the material in which the doping material is mixed into the host material is employed, and the doping material (molecules) emits a light. As the host material, there are Alq3 and a distyrylarylene derivative (DPVBi), for example, while as the doping material, there are a coumalin 6 for the emission of green light and DCJTB for the emission of red light, for example.

When a full color display is implemented by respective light emitting layers 54 for the three primary colors, a red light emitting layer, a green light emitting layer, and a blue light emitting layer are formed on the electron transporting layers 52 of the pixel portions (not shown) for three primary colors (red (R), green (G), and blue (B)) respectively. Otherwise, when a white light emitting layer is employed as the light emitting layer 54, the full color display can be implemented by combining the white light emitting layer with color filters.

Then, as shown in FIG. 5, a hole transporting layer 56 is formed selectively on the light emitting layer 54 by the mask deposition method, or the like. As the hole transporting layer 56, α-NPD that is an aromatic tertiary amine derivative, or the like is employed preferably.

Otherwise, the electron transporting layer 52, the light emitting layer 54, and the hole transporting layer 56 are formed by the ink jet system as a pattern respectively.

Accordingly, an organic EL layer 50 composed of the electron transporting layer 52, the light emitting layer 54, and the hole transporting layer 56 is obtained.

In this case, a mode in which only either of the electron transporting layer 52 and the hole transporting layer 56 is formed may be employed, or such a mode in which both the electron transporting layer 52 and the hole transporting layer 56 are omitted may be employed.

Then, as also shown in FIG. 5, an anode 58 opposing to the cathode 26 is formed selectively on the hole transporting layer 56 by the mask deposition method, or the like. The anode 58 may be formed of a transparent conductive layer such as an ITO (Indium Tin Oxide) layer, an IZO (Indium Zinc Oxide) layer, or the like, or the anode 58 may be formed of an opaque conductive layer such as a gold (Au) layer, a platinum (Pt) layer, a silver (Ag) layer, or the like.

As described later, the cathode 26 and the anode 58 are composed as a combination in which one is the transparent conductive layer and the other is the opaque conductive layer. A combination of the transparent and opaque in them is selected depending on whether the light emitted from the organic EL layer 50 is passed through the anode 58 or the cathode 26.

Accordingly, an organic EL element 2 composed of the cathode 26, the organic EL layer 50, and the anode 58 is obtained.

Then, as also shown in FIG. 5, a second protection insulating layer 59 is formed on the organic EL element 2 to cover it. Like the first protection insulating layer 46 described above, the second protection insulating layer 59 is formed by stacking the inorganic insulating layer on the resin layer or stacking the resin layer on the inorganic insulating layer.

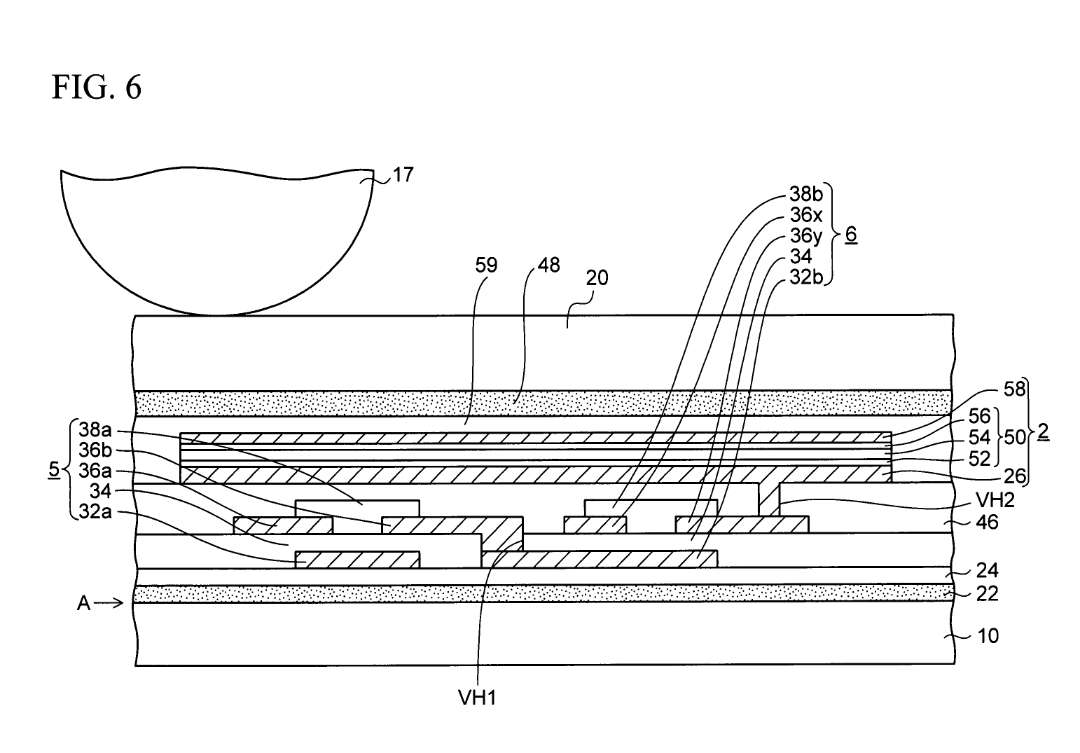

Then, as shown in FIG. 6, a plastic film 20 is arranged on an upper surface of the second protection insulating layer 59 to oppose to the second protection insulating layer 59 via the adhesive layer 48. Then, the adhesive layer 48 is cured by the heat treatment, and thus the plastic film 20 is adhered onto the structure in FIG. 5. As the plastic film 20, a polyether sulfone film, a polycarbonate film, or the like, which has a film thickness of 100 to 200 μm, is employed preferably.

Then, as also shown in FIG. 6, a roller 17 is fixed to one end of the plastic film 20, and then the glass substrate 10 is peeled while causing the roller 17 to rotate. At this time, the glass substrate 10 is peeled along a boundary between the transparent peelable layer 22 and the glass substrate 10 (A portion in FIG. 6). Then, the glass substrate 10 is disposed.

In FIG. 7, such a state is shown that the glass substrate 10 is removed from the structure in FIG. 6 and then the top and bottom of the resultant structure is reversed. As shown in FIG. 7, the adhesive layer 48, the second protection insulating layer 59, the organic EL element 2, the first protection insulating layer 46, the Sw-TFT 5 and the Dr-TFT 6, the buffer layer 24, and the transparent peelable layer 22 are transferred/formed in sequence from the bottom on the plastic film 20. The transparent peelable layer 22 exposed on the uppermost surface is left as a surface protection layer 23.

With the above, a flexible organic EL display 1 of the present embodiment is obtained.

As shown in FIG. 7, in the flexible organic EL display 1 of the present embodiment, an adhesive layer 48 and the second protection insulating layer 59 (lower insulating layer) are formed sequentially on the plastic film 20. The organic EL element 2 is embedded in the second protection insulating layer 59. In the present embodiment, since the foregoing transfer technology is employed, the organic EL element 2 formed on the glass substrate 10 is arranged in a state that the top and bottom reverses.

The organic EL element 2 is constructed by stacking the anode 58, the organic EL layer 50, and the cathode 26 sequentially from the bottom. The organic EL layer 50 is constructed by stacking the hole transporting layer 56, the light emitting layer 54, and the electron transporting layer 52 sequentially from the bottom. Then, the organic EL element 2 is embedded in the second protection insulating layer 59 such that an upper surface of the cathode 26 and an upper surface of the second protection insulating layer 59 constitute the identical surface.

Also, the first protection insulating layer 46 is formed on the organic EL element 2. The Sw-TFT 5 and the Dr-TFT 6 are embedded side by side in the lateral direction in the first protection insulating layer 46. Like the organic EL element 2, the Sw-TFT 5 and the Dr-TFT 6 formed on the glass substrate 10 are arranged in a state that the top and bottom reverses.

The Sw-TFT 5 is constructed by forming the oxide semiconductor layer 38a, the source electrode 36a and the drain electrode 36b, the gate insulating layer 34, and the gate electrode 32a sequentially from the bottom. Similarly, the Dr-TFT 6 is constructed by forming the oxide semiconductor layer 38b, the source electrode 36x and the drain electrode 36y, the gate insulating layer 34, and the gate electrode 32b sequentially from the bottom.

The respective source electrodes 36a, 36x and the respective drain electrodes 36b, 36y are arranged to extend from the inner areas of the gate electrodes 32a, 32b to the outer side. The oxide semiconductor layers 38a, 38b arranged in the opposing areas located between them constitute the channel portions of respective TFTs.

Also, the buffer layer 24 and the transparent peelable layer 22 are formed in order on the Sw-TFT 5 and the Dr-TFT 6. The transparent peelable layer 22 functions as the surface protection layer 23.

In the Sw-TFT 5 and the Dr-TFT 6 in FIG. 7, the bottom contact type in which the oxide semiconductor layers 38a, 38b contact bottoms (lower portions) of the source electrodes 36a, 36x and the drain electrodes 36b, 36y is employed. In this case, the top contact type in which the oxide semiconductor layers 38a, 38b contact tops (upper portions) of the source electrodes 36a, 36x and the drain electrodes 36b, 36y may be employed.

In the method of manufacturing the flexible organic EL display of the present embodiment, on the glass substrate 10, the oxide semiconductor TFT (the Sw-TFT 5 and the Dr-TFT 6) is formed between the buffer layer 24 and the first protection insulating layer 46, the organic EL element 2 is formed between the first protection insulating layer 46 and the second protection insulating layer 59, and these elements are transferred onto the plastic film 20.

By employing such approach, the organic EL element 2 is formed under the oxide semiconductor TFT (the Sw-TFT 5 and the Dr-TFT 6) such that this element is protected with the first and second protection insulating layers 46, 59 and embedded therein. As a result, such a situation can be prevented that steam from an outside air and moisture in the plastic film 20 enter into the organic EL element 2, and thus reliability of the organic EL element 2 can be improved.

Also, as content should be mentioned specially, the organic EL element 2 is protected with the multi-layered gas barrier layer composed of the buffer layer 24, the gate insulating layer 34, and the first protection insulating layer 46,and which is provided to the surface on the TFTs 5, 6 side, thereby higher reliability can be obtained.

Further, in the present embodiment, since the transfer technology is utilized, in the formation of the gate insulating layer 34, the insulating layer not containing the hydroxyl group can be formed by heat-treating the coating film such as poly(vinyl phenol), or the like at a temperature of 180° C. or more on the glass substrate 10. Therefore, the gate insulating layer 34 that has a sufficient dielectric breakdown electric field strength (1 MV/cm or more) and can follow a bending stress can be transferred/formed on the plastic film 20.

Also, in the present embodiment, since the transfer technology is utilized, the oxide semiconductor layers 38a, 38b can be thermally treated on the glass substrate 10 at a temperature of 200° C. or more upon forming the oxide semiconductor layers 38a, 38b. Accordingly, the oxide semiconductor layers 38a, 38b function as the active layer of the TFT with the desired electric characteristics (Vth, etc.), and the TFT which has stable electric characteristics and whose reliability is high can be constructed.

Also, the transparent peelable layer 22 is used as the separating layer at a time of the transfer operation. Thus, the transparent peelable layer 22 exposed after the glass substrate 10 is peeled off can be utilized as the surface protection layer 23. Therefore, in the manufacturing method utilizing the transfer technology, there is no necessity to remove the peeling layer or to form particularly the surface protection layer. As a result, the manufacturing steps can be simplified and a cost reduction can be achieved.

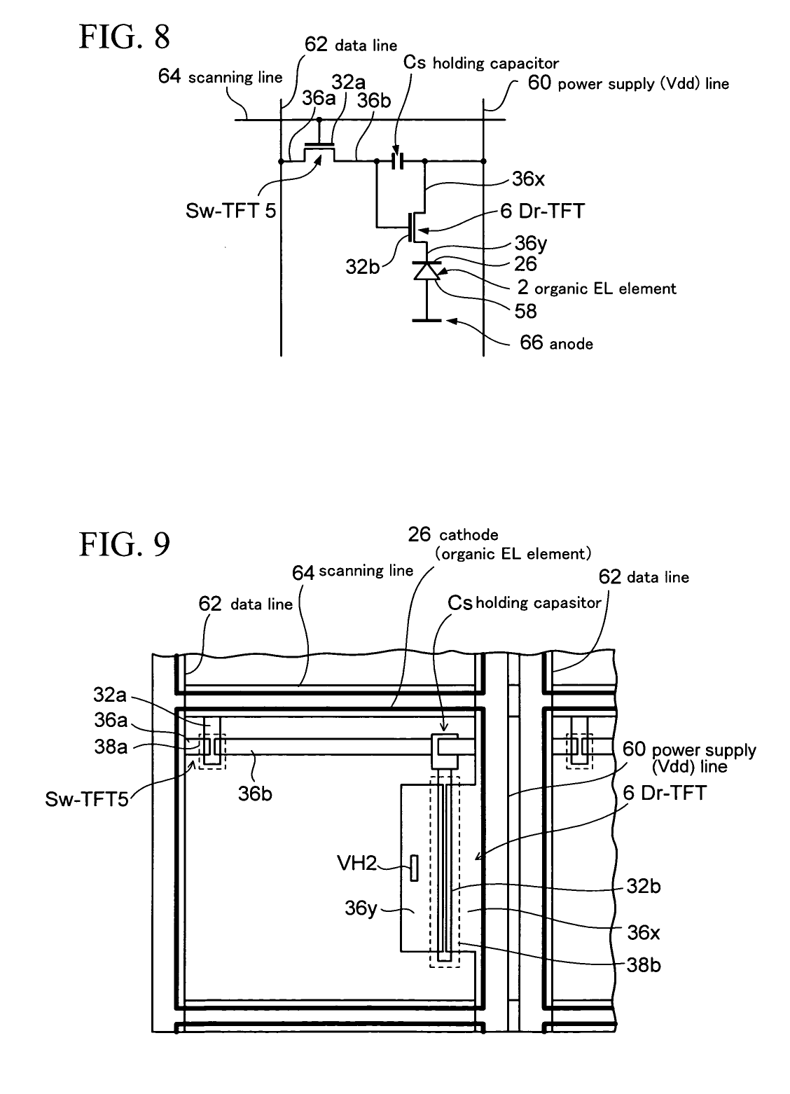

FIG. 8 is a view showing an equivalent circuit of one pixel portion of the flexible organic EL display according to the embodiment of the present invention, and FIG. 9 is a plan view showing an example of a layout of the pixel portion in the flexible organic EL display according to the embodiment of the present invention.

An equivalent circuit in FIG. 8 will be explained while referring to appropriately a plan view in FIG. 9 hereunder. The anode 58 of the organic EL element 2 is connected to an anode 66, and the cathode 26 of the organic EL element 2 is connected to the drain electrode 36y of the Dr-TFT 6 via the via hole VH2. The source electrode 36x of the Dr-TFT 6 is connected to a power supply (Vdd) line 60.

Also, a holding capacitor Cs is formed between the gate electrode 32b of the Dr-TFT 6 and the power supply (Vdd) line 60. Also, the drain electrode 36b of the Sw-TFT 5 is connected to the gate electrode 32b of the Dr-TFT 6, and the source electrode 36a of the Sw-TFT 5 is connected to a data line 62. Further, the gate electrode 32a of the Sw-TFT 5 is connected to a scanning line 64.

The equivalent circuit in FIG. 8 operates as follows. First, when a potential of the scanning line 64 is set to a selection state and then a writing potential is applied to the data line 62, the Sw-TFT 5 becomes conductive state and the holding capacitor Cs is charged or discharged, and then a gate potential of the Dr-TFT 6 is set to a writing potential. Then, when a potential of the scanning line 64 is set to a non-selection state, the Dr-TFT 6 is disconnected electrically from the data line 62, but a gate potential of the Dr-TFT 6 is held stably by the holding capacitor Cs.

Then, a current flowing to the Dr-TFT 6 and the organic EL element 2 has a value that responds to a gate-source voltage of the Dr-TFT 6. Thus, the organic EL element 2 continues to emit a light at a luminance that responds to the current value.

A pixel having such constitutions are aligned plurally in a matrix fashion and the writing is repeated through the data line 62 while sequentially selecting the scanning line 64, thereby an active-matrix type organic EL display can be composed. In this manner, the light is emitted from the light emitting layers 54 of respective pixel portions to the outside, and the image can be obtained.

The flexible organic EL display 1 in FIG. 7 shows such a mode that the cathode 26 is formed of the transparent layer and the anode 58 is formed of the opaque layer. In this case, the light emitted from the light emitting layer 54 is passed through the cathode 26 and is emitted to the outside (an arrow direction in FIG. 7). That is, the light is not passed through the plastic film 20 and is emitted to the opposite side.

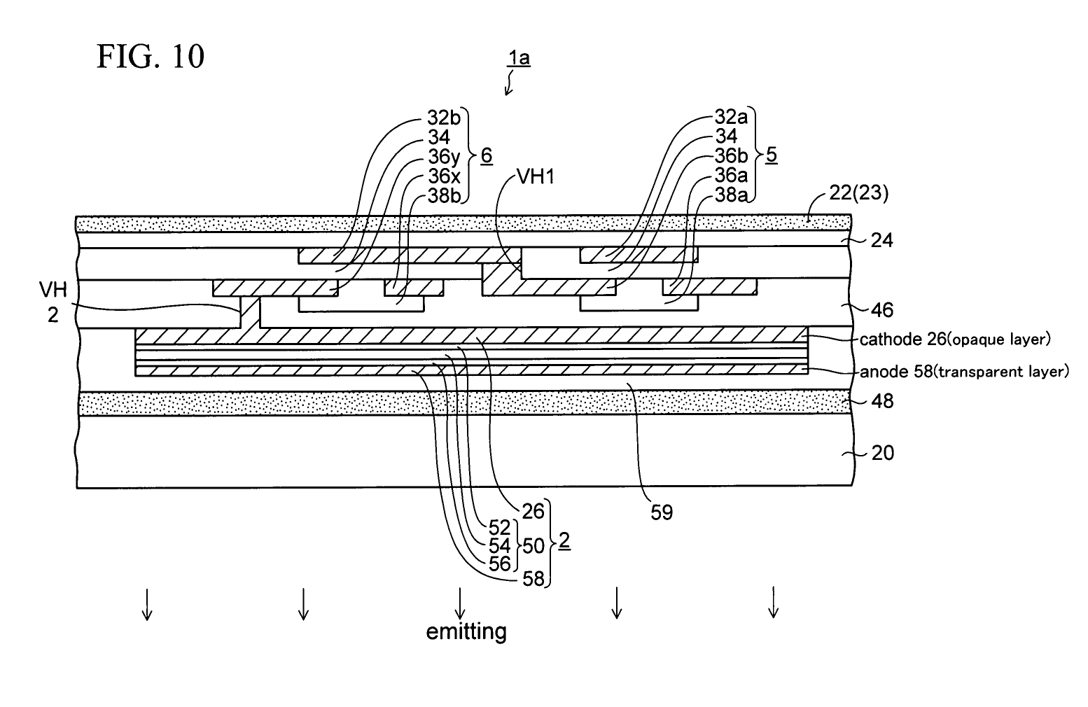

In FIG. 10, a flexible organic EL display lain which the cathode 26 is formed of the opaque layer and the anode 58 is formed of the transparent layer, on the contrary to FIG. 7, is shown. In this case, the light emitted from the light emitting layer 54 is passed through the anode 58 and is emitted to the outside (an arrow direction in FIG. 10). That is, the light is passed through the plastic film 20 and is emitted to the outside.

In particular, in the flexible organic EL display la in FIG. 10, the light is emitted to the opposite side to the TFTs 5, 6 (the plastic film 20 side). Therefore, a high aperture ratio can be obtained even when the TFTs 5, 6 are formed of the opaque layer. Also, since the TFTs 5, 6 are arranged to overlap with the anode 58, a high aperture ratio can be obtained from such a viewpoint that an area of the anode 58 can be increased.

In FIG. 10, respective constituent elements are similar to those in FIG. 7, and therefore their explanation will be omitted herein by affixing the same reference symbols.

In this manner, in the flexible organic EL displays 1, la of the present embodiment, the light can be emitted from the plastic film 20 side or the opposite side to the plastic film 20, by controlling the transparent/opaque combination between the cathode 26 and the anode 58.

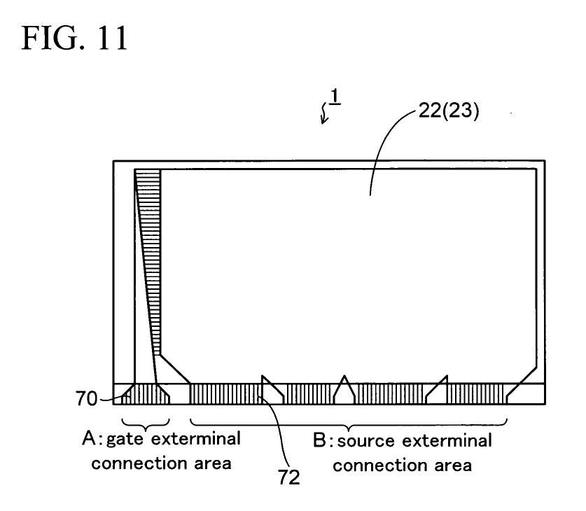

Next, an external connection area of the flexible organic EL display of the present embodiment will be explained hereunder. FIG. 11 is a plan view showing an external connection area of the flexible organic EL display according to the embodiment of the present invention. As shown in FIG. 11, a gate external connection area A and a source external connection area B are provided to one end side of the flexible organic EL display 1.

In the gate external connection area A, a large number of gate connection electrodes 70 connected to the scanning line (64 in FIG. 8) connected to the gate electrodes 32a of the Sw-TFTs 5 are arranged side by side. Also, in the source external connection area B, a large number of source connection electrodes 72 connected to the data line (62 in FIG. 8) connected to the source electrodes 36a of the Sw-TFTs 5 are arranged side by side.

The transparent peelable layer 22 is left in the main portion of the flexible organic EL displays 1 as the surface protection layer 23. But the stacked films containing the surface protection layer 23 are removed collectively in the gate external connection area A and the source external connection area B, and the gate connection electrode 70 and the source connection electrode 72 are exposed.

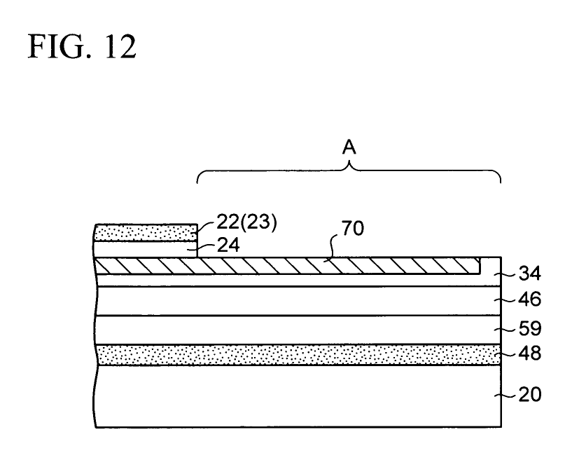

That is, by reference to FIG. 12 (a sectional view of the longitudinal direction of the gate connection electrode 70 in FIG. 11) in addition, the transparent peelable layer 22 (the surface protection layer 23) and the buffer layer 24 under it are removed in the gate external connection area A, and a plurality of gate connection electrodes 70 are exposed.

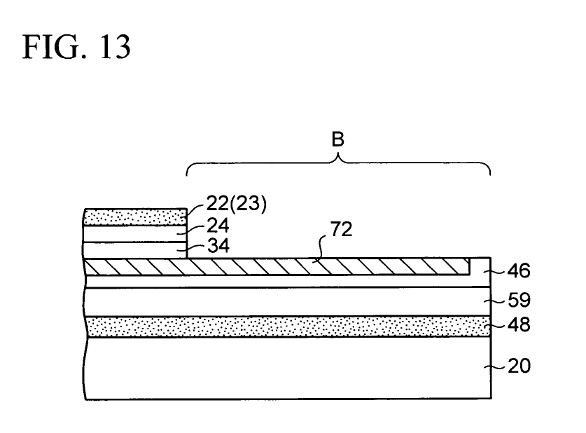

Also, by reference to FIG. 13 (a sectional view of the longitudinal direction of the source connection electrode 72 in FIG. 11) in addition, in the source external connection area B, the transparent peelable layer 22(the surface protection layer 23), the buffer layer 24 and the gate insulating layer 34 under it are removed, and a plurality of source connection electrodes 72 are exposed. The gate connection electrodes 70 and the source connection electrodes 72 are connected to the scanning line 64 and the data line 62, respectively.

In order to expose the gate connection electrodes 70 and the source connection electrodes 72, a mask for protecting the display area but exposing collectively the external connection areas A, B may be arranged, and then the stacked film containing the surface protection layer 23 may be etched via the mask by the plasma etching, or the like.

What is claimed is:

1. A flexible organic EL display of active matrix type in which a TFT and an organic EL element are provided in every pixel, comprising:
a plastic film;
an adhesive layer formed on the plastic film;
a lower insulating layer formed on the adhesive layer;
the organic EL element embedded in the lower insulating layer and constructed by forming an anode, an organic EL layer, and a cathode sequentially from a bottom;
an upper insulating layer formed on the organic EL element;
the TFT embedded in the upper insulating layer, and constructed by forming an oxide semiconductor layer, a source electrode and a drain electrode, a gate insulating layer, and a gate electrode sequentially from a bottom; and
a via hole provided in the upper insulating layer and reaching the drain electrode of the TFT;
wherein the cathode is connected electrically to the drain electrode of the TFT via the via hole.

2. A flexible organic EL display according to claim 1, further comprising:
a buffer layer formed on the TFT and made of an inorganic insulating layer; and
a surface protection layer formed on the buffer layer and made of transparent polyimide.

3. A flexible organic EL display according to claim 1, wherein the gate insulating layer of the TFT is formed of an inorganic insulating layer, or an insulating layer that contains no hydroxyl group and is obtained by polymerizing/cross-linking poly vinyl phenol, poly methyl silsesquioxane, or polyimide by applying a heat treatment.

4. A flexible organic EL display according to claim 1, wherein the oxide semiconductor layer of the TFT is thermally treated at a temperature of 200 to 300° C.

5. A flexible organic EL display according to claim 2, wherein an external connection area in which a gate connection electrode connected electrically to the gate electrode of the TFT and a source connection electrode connected electrically to the source electrode of the TFT are arranged respectively is provided in an end side of the flexible organic EL display, and a stacked film containing the surface protection layer is removed in the external connection area, and the gate connection electrode and the source connection electrode are exposed.

6. A flexible organic EL display according to claim 1, wherein the TFT is composed of a switching TFT and a driving TFT connected to the switching TFT, and the drain electrode of the driving electrode is connected to the cathode, and
a via hole reaching the gate electrode of the driving TFT is provided in the gate insulating layer, and the drain electrode of the switching TFT is connected electrically to the gate electrode of the driving TFT via the via hole.

7. A flexible organic EL display according to claim 1, wherein the organic EL layer is composed of
a light emitting layer, and
at least one of an electron transporting layer formed between the cathode and the light emitting layer, and a hole transporting layer formed between the light emitting layer and the anode.

8. A method of manufacturing a flexible organic EL display of active matrix type in which a TFT and an organic EL element are provided in every pixel, comprising the steps of:
forming a transparent peelable layer on a temporary substrate;
forming the TFT constructed by forming a gate electrode, a gate insulating layer, a source electrode and a drain electrode, and an oxide semiconductor layer over the transparent peelable layer sequentially from a bottom;
forming a first insulating layer on the TFT;
forming a via hole reaching the drain electrode of the TFT, by processing the first insulating layer;
forming the organic EL element composed of a cathode connected to the drain electrode via the via hole, an organic EL layer formed on the cathode, and an anode formed on the organic EL layer, on the first insulating layer;
forming a second insulating layer on the organic EL element;
adhering a plastic film onto the second insulating layer via an adhesive layer; and
transferring/forming the second insulating layer, the organic EL element, the first insulating layer, the TFT, and the transparent peelable layer onto the plastic film via the adhesive layer, by peeling the temporary substrate along a boundary between the temporary substrate and the transparent peelable layer.

9. A method of manufacturing a flexible organic EL display according to claim 8, after the step of forming the transparent peelable layer, further comprising:
a step of forming a buffer layer made of an inorganic insulating layer on the transparent peelable layer.

10. A method of manufacturing a flexible organic EL display according to claim 8, wherein after the step of transferring/forming onto the plastic film, the transparent peelable layer is left as a surface protecting layer.

11. A method of manufacturing a flexible organic EL display according to claim 8, wherein, in the step of forming the TFT, the gate insulating layer is formed of an insulating layer that contains no hydroxyl group and is obtained by polymerizing/cross-linking poly vinyl phenol, poly methyl silsesquioxane, or polyimide by applying a heat treatment.

12. A method of manufacturing a flexible organic EL display according to claim 8, wherein the oxide semiconductor layer of the TFT is thermally treated at a temperature of 200 to 300° C. in the step of forming the TFT.

13. A method of manufacturing a flexible organic EL display according to claim 10, wherein an external connection area in which a gate connection electrode connected electrically to the gate electrode of the TFT and a source connection electrode connected electrically to the source electrode of the TFT are arranged respectively is provided in an end side of the flexible organic EL display, and
after the step of transferring/forming onto the plastic film, the gate connection electrode and the source connection electrode are exposed by removing a stacked film containing the surface protecting layer in the external connection area.
